(19) United States
(12) Patent Application Publication
(10) Pub. No.: US 2011/0141762 A1
(43) Pub. Date: Jun. 16, 2011

(54) SECONDARY OPTICAL SYSTEM

(76) Inventor: Jean-Hway LEE, Danshuei Township (TW)

(21) Appl. No.: 12/906,571

(22) Filed: Oct. 18, 2010

(30) Foreign Application Priority Data
Dec. 10, 2009 (TW) 098142190

(51) Int. Cl. F21S 4/00

(52) U.S. Cl. 362/565

(57) ABSTRACT

A secondary optical system provides radial scattered light (decoration light) to optical fibers for decoration and can aid a light decoration system to be more saturated and uniform, as well as extend a transmission distance. The present invention utilizes a flexible optical tube, a hollow piping of which provides for pivoting with the optical fibers. An outer surface of the tube is provided with an optical layer by which forward reflection is acted on part of a radial scattered beam generated by the optical fibers, so as to synthesize a longer transmission distance. The present invention is also provided with a light shielding function, allowing part of a refraction beam to form diffusion and an outward scattering effect, such that an entire outer surface of the system can irradiate out decoration light of high uniformity and high saturation intensity.

### BACKGROUND OF THE INVENTION

a) Field of the Invention

The present invention relates to a secondary optical system, and more particular to an optical system which provides radial scattered light (decoration light) to optical fibers for decoration, facilitating a decoration light system to be more saturated and uniform, with a longer transmission distance.

b) Description of the Prior Art

For environment of lower brightness, in addition to providing illumination, an electro-optical illuminator can be utilized to project light and change light color, thereby increasing lumen and providing a sense of gorgeousness and beauty. On the other hand, for a directional or limited illumination portion, a light transmission design can be even utilized; for example, an optical fiber which is arranged in a line or band, or an electro luminescent, can all be used as the lighting decoration in a surface, line or band.

Regarding to the design of optical fiber transmission, the present inventor has already filed a patent application to Taiwan and United States, such as the U.S. Pat. No. 5,901,267, “Optical Fiber having Continuous Spot-Illumination.” In this patent, the spot-shaped light source is emitted from the micro-windows to generate the bright light pedals of strong contrast, along with the radial scattered light of the spun fibers or the background light of environment. As shown in FIG. 1, the optical system utilizes a light guiding element 3 which is formed by plural spun fibers, with an outer surface of each spun fiber being cut to generate the spot-shaped micro-windows, followed by being assembled as bunches. Accordingly, plural micro-windows are distributed on an outer surface of the light guiding element 3 and after transmission through a core, a traveling beam B will form plural spot-shaped light sources 300 on the outer surface of the light guiding element 3.

An outer circumference of the light guiding element 3 is sheathed by a transparent tube 1 for protection. As the transparent tube 1 is transparent, from an outside of the transparent tube 1, a user can see a scattered beam B₀ which is emitted through the light guiding element 3 by the traveling beam B and a first refraction beam Bₜ₁ which is refracted from the transparent tube 1, forming a scattered light stream 11 after penetrating out. On the other hand, light beams which are generated by the spot-shaped light sources 300 will form light pedals 12 after refracting out of the transparent tube 1. Therefore, the light pedals 12 are similarly in a shape of spot, when being seen from the outer surface of the transparent tube 1; whereas, the scattered light stream 11 penetrates out directly. The shape of the light guiding element 3 can be clearly seen from the outside of the transparent tube 1 and the scattered beam B₀ is refracted out directly; thus, the scattered beam B₀ at that spot is of full intensity and is lost from the spot.

### SUMMARY OF THE INVENTION

The primary object of the present invention is to provide an optical system which is provided with a secondary assistance function, utilizing a flexible and refractive optical tube, a hollow piping of which provides for pivoting a flexible and bendable light guiding element, such that by forward reflection of the optical tube, a distance of beam transmission for the system can be increased and a scattered beam for light decoration can be restrained to reach saturation and finally to be highly uniformly diffused.

A second object of the present invention is to provide a secondary optical system, wherein an optical layer of the system is a layer of high crystallization which is hydrophilic by its high density.

A third object of the present invention is to provide a secondary optical system, wherein a refraction index of the optical layer of the system is small, but a reflection index is large.

A fourth object of the present invention is to provide a secondary optical system, wherein the light guiding element is made by plastic spun fibers which are assembled as bunches to synthesize higher scattering intensity.

A fifth object of the present invention is to provide a secondary optical system, wherein the optical layer and the tube are formed integrally and the optical layer is elastic and extensible.

A sixth object of the present invention is to provide a secondary optical system, wherein an interior of the optical tube is provided with optical particles to achieve a higher diffusion index.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional light decoration system.

FIG. 2 shows a schematic view of an optical tube of the present invention.

FIG. 3 shows a schematic view of the optical tube which is combined with a light guiding element, according to the present invention.

FIG. 4 shows a schematic view of forward refraction of beams which are provided by the optical system, according to the present invention.

FIG. 5 shows a schematic view of a path along which the beams provided by the present invention are diffused out.

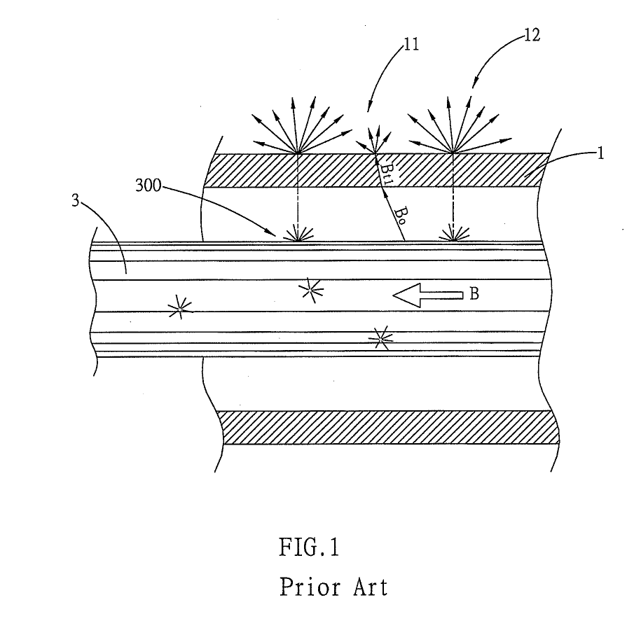

### DETAILED DESCRIPTION OF THE PREFERRED EMBODIMENTS

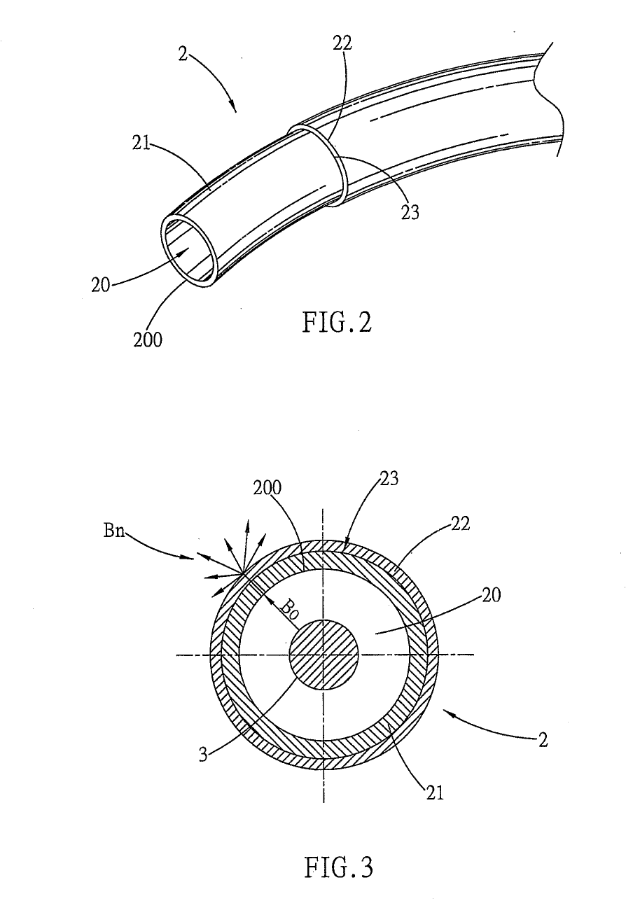

Referring to FIG. 2 and FIG. 3, the present invention provides an optical system of light transmission used for light decoration, with effects of assisting increase of a transmission distance at an outer circumference of the system and of allowing light emitted outside the system to be more saturated and uniform.

The present system utilizes an optical tube 2 which is provided with a flexible and refractive tube unit 21 as a main body. A hollow piping 20 is formed at a cross section of the tube unit 21 and is defined by an inner cross section of an incident surface 200 on an inner circumference. An outer surface of the tube unit 21 is tightly enclosed by an optical layer 22 between which and the tube unit 21 is formed with an optical interface 23. The said hollow piping 20 provides for pivoting with a light guiding element 3 in a shape of long line.

The light guiding element 3 is basically a light conductor. After being implemented by plural spun fibers which are assembled as bunches, the light guiding element 3 in a shape of single unit is formed. The light guiding element 3 is used for light decoration and hence it will be provided with loss light which is scattered in a radial direction.

After a radial scattered beam B₀, which is generated by the light guiding element 3, has undergone an optical reaction with the optical tube 2, part of light intensity will be distributed on an outer surface of the optical tube 2, forming a decoration light Bₙ.

The abovementioned optical layer 22 is made by polymer and is capable of inward reflection and outward refraction. In addition, by using the polymeric optical material to form the outer surface enclosing the tube unit 21, the optical tube 2 is hydrophilic and will not be hydrolyzed. Therefore, the optical tube 2 can be deployed in a hydrophilic site for use in a long time, such as a bottom of a swimming pool, where the light Bₙ emitted can serve as the explicit light decoration and be used for alerting.

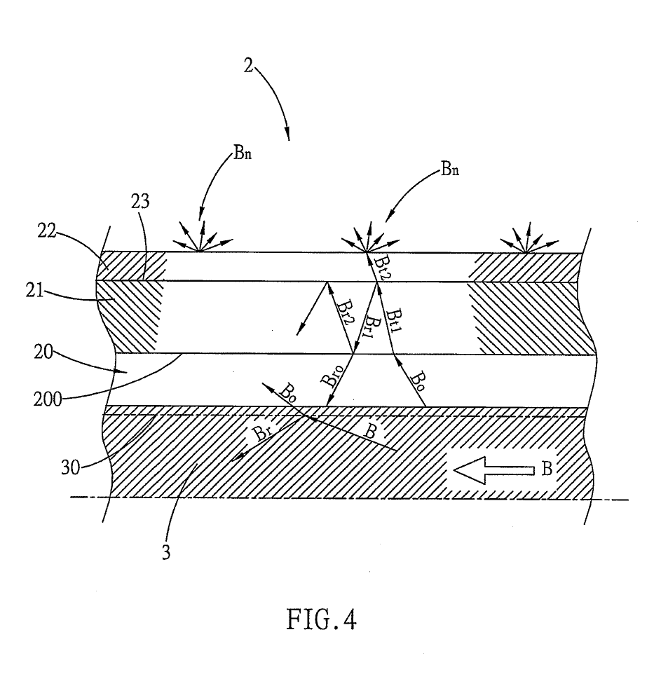

Referring to FIG. 4, the optical tube 2 disclosed by the present invention includes a refractive and flexible tube unit 21 in the system.

An interior of the optical tube 2 is provided with a hollow piping 20 defined by an incident surface 200 on an inner circumference. The hollow piping 20 provides for pivoting with a light guiding element 3.

The light guiding element 3 itself is formed with an incident port which is able to receive an external light source (not shown in the drawing) and reflect forward. After entering, an external traveling beam B will move forward in a core of the light guiding element 3. The forward moving way is that the traveling beam B utilizes an inner reflection surface 30 of the light guiding element 3 to achieve a reflection pattern, forming a reflection beam Bᵣ and resulting in a forward moving action of light transmission by using a marching angle of a component of the reflection beam Bᵣ. In addition, as being made by the optical fibers for light decoration, the light guiding element 3 has to be provided with part of the radial scattered light. Therefore, part of the outward scattered beam B₀ will be formed on the inner reflection surface 30 and that scattered beam B₀ is a light source of a sideway light decoration of an ordinary spun fiber of decoration.

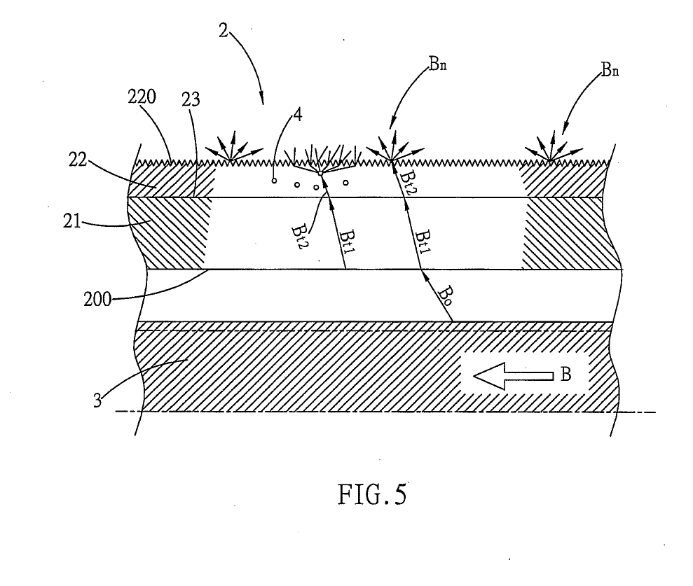

To aid in the marching of light transmission and allow the decoration light Bₙ to be uniform and saturated, the outer surface of the tube unit 21 is combined with the optical layer 22 between which and the tube unit 21 is formed with the optical interface 23. The optical interface 23 is reflective and refractive and its reflection index can be larger than the refraction index. On the contrary, the refraction index of the tube unit 21 is larger than that of the optical interface 23. Therefore, a first refraction light Bₜ₁ resulting from the scattered beam B₀ which enters from the incident surface 200 will form a first reflection beam Bᵣ₁ on the optical interface 23; whereas, part of the first refraction light Bₜ₁ will radiate out a second refraction light Bₜ₂ from the outer surface 220 (as shown in FIG. 5). Then, a second reflection beam Bᵣ₂ is formed by inner reflection of the incident surface 200. The first reflection beam Bᵣ₁, the traveling beam B and the second reflection beam Bᵣ₂ are forward directional; therefore, the traveling beam B can be extended and the beams resulted can be transmitted to a farther port, thereby helping to obtain a longer distance of light transmission. Furthermore, using the inner refraction of the tube unit 21, the first refraction light Bₜ₁ that enters will be filled in the tube unit 21. Hence, each beam in the tube unit 21 will be restrained by the internal part (within thickness) to be filled in every solid angle and saturated. The saturation function can improve the decoration light Bₙ at the outer surface of the optical tube 2 to acquire high uniformity due to the function of multiple angles, which is the base of first uniform illumination of the present invention.

The optical interface 23 is refractive and will form part of the second refraction light Bₜ₂. After being refracted from the optical layer 22, the second refraction light Bₜ₂ will form the outward light Bₙ on the surface. Thus, no matter what lumen and uniformity of the light guiding element 3 is provided with, the outward light Bₙ which is distributed from the optical layer 22 will be more uniform, after going through the reflection and the refraction of the tube unit 21. In addition, under a condition that the reflection index of the optical interface 23 is large, the scattered beam B₀ which enters from the incident surface 200 will be refracted and reflected according to the Snell's law, where the extended length of marching distance is determined by an angle at which the scattered beam B₀ enters into the incident surface 200 and by intensity of a light source.

After entering from the incident surface 200, the scattered beam B₀ will form the first reflection beam Bᵣ₁ through the reflection of the optical interface 23. When the first reflection beam Bᵣ₁ acts on the incident surface 200, the second reflection beam Bᵣ₂ will be formed according to the reflection in a dense medium of the incident surface 200. Therefore, each beam that results from the entering of the scattered beam B₀ will move forward as a wave in the tube unit 21, thereby allowing the beams to transmit to a longer distance.

Part of the first refraction light Bₜ₁ that travels in the tube unit 21 is reflected by the optical interface 23 as the first reflection beam Bᵣ₁ and part of the first reflection beam Bᵣ₁ will penetrate out of the incident surface 200 in a reverse direction to form a reverse outward beam Bᵣ₀; whereas, a component of the reverse outward beam Bᵣ₀ will follow an ultimate orientation of the traveling beam B to march. Thus, whether for the marching of the first reflection beam Bᵣ₁ or the second reflection beam Bᵣ₂, the reverse outward beam Bᵣ₀ will be included, such that the beams that come out of the light guiding element 3 can all be assisted in marching, as long as the beams are within a critical reflection angle of any optical surface.

Referring to FIG. 5, the system of the optical tube 2 of the present invention includes the tube unit 21 and the internal light guiding element 3. The outer surface of the tube unit 21 is combined with the optical layer 22 and the light guiding element 3 obtains the traveling beam B at one port. After being scattered in a radiation direction, the traveling beam B will form the scattered beam B₀ which enters into the tube unit 21 from the incident surface 200. The first refraction light Bₜ₁ that enters will form the second refraction light Bₜ₂ through the refraction of the optical interface 23 and the second refraction light Bₜ₂ will cross over the optical layer 22 to diffuse out. Therefore, the decoration light Bₙ will be formed on the outer surface 220 of the optical layer 22, wherein the outer surface 220 can be formed with a rough surface to become irregular refraction, allowing the light Bₙ which is formed after the second refraction light Bₜ₂ has radiated out to diffuse more uniformly, which is the base of second uniform illumination of the present invention.

In the present invention, an interior of the optical layer 22 can be filled with optical particles 4 which are metallic materials or gas bubbles, as long as that an optical reflection can be formed on surfaces thereof. Therefore, after undergoing the refraction of the optical interface 23, the first refraction light Bₜ₁ that enters from the light guiding element 3 will irradiate toward the optical particles 4 and using an unlimited angle on a curve of a surface of the optical particle 4, a diffusion function will be resulted after the second refraction light Bₜ₂ has reached the optical particles 4, thereby forming plural split beams. The beams after diffusion will form the very uniform light Bₙ on the outer surface, which is the base of third uniform illumination of the present invention.

The implementation of the abovementioned optical particles 4 can be similarly applied in the interior of the tube unit 21 to achieve a diffusion operation in advance, diffusing concentration of the beams.

The present invention provides an optical system of the optical tube 2, as shown in FIGS. 2 to 5. The optical system utilizes primarily the tube unit 21, the interior, of which is formed with the hollow piping 20 by the incident surface 200 on the inner circumference. The hollow piping 20 provides for pivoting with the light guiding element 3 and that pivoting is movable, allowing the light guiding element 3 to move freely. The tube unit 21 is refractive and the outer surface of the tube unit 21 is tightly combined with the optical layer 22, forming the optical interface 23 between the tube unit 21 and the optical layer 22. By the refraction and the reflection of the optical interface 23, the second refraction light Bₜ₂ and the first reflection beam Bᵣ₁ can be formed after the scattered beam B₀ that is scattered by the light guiding element 3 has entered into the tube unit 21. In addition, by the inner reflection of the incident surface 200, the second reflection beam Bᵣ₂ can be formed. Therefore, the transmission distance can be extended and the light Bₙ on the outer surface of the optical tube 2 can be more uniform.

The tube unit 21 and the optical layer 22 can be formed integrally and is made by drawing simultaneously. The optical layer 22 is made by polymer and is provided with an elastic strain capability of extension. The tube unit 21 is also flexible. Therefore, when being deployed in a curve at a light decoration site, if the surface of the tube unit 21 is formed with a change of curvature, then the optical layer 22 can be tightly combined to deform simultaneously, keeping the integrity of the optical interface 23. Besides, the light guiding element 3 used is also flexible and bendable to provide for deployment in a curvature of water liquid, to increase the distance of light transmission and to uniform the outward decoration light, after fitting the entire system, which is the primary object of the present invention. Besides, according to the implementation in FIGS. 2 to 5, the implementation demand can be clearly achieved.

It is of course to be understood that the embodiments described herein is merely illustrative of the principles of the invention and that a wide variety of modifications thereto, as long as that the outer surface of the light guiding element 3 is implemented with a design to aid in extending the transmission distance and that the design is provided with the outward refraction capability, may be effected by persons skilled in the art without departing from the spirit and scope of the invention as set forth in the following claims.

What is claimed is:

1. A secondary optical system which provides radial scattered light (decoration light) to optical fibers for decoration, facilitating a decoration light system to be more saturated and uniform, with a longer transmission distance, comprising:
a light guiding element in a shape of long line, a radial surface of which generates a scattered beam; and
an optical tube, which is a refractive tube unit and an inner circumference of which is an incident surface, forming a hollow piping in an interior of cross section by definition of the incident surface; the optical tube providing for pivoting with the light guiding element and an outer surface of the tube unit being tightly combined with an optical layer, forming an optical interface which is refractive and reflective.

2. The secondary optical system according to claim 1, wherein a refraction index of the tube unit is larger than that of the optical interface.

3. The secondary optical system according to claim 1, wherein the optical interface and the tube unit are formed integrally.

4. The secondary optical system according to claim 1, wherein the optical layer is made by polymer.

5. The secondary optical system according to claim 1, wherein the optical layer is elastic and extensible.

6. The secondary optical system according to claim 1, wherein an interior of the optical layer is distributed with optical particles.

7. The secondary optical system according to claim 1, wherein an interior of the tube unit is distributed with optical particles.

8. The secondary optical system according to claim 1, wherein the light guiding element is formed by plural spun fibers which are assembled as bunches.
